(19) United States
(12) Patent Application Publication
(10) Pub. No.: US 2024/0090505 A1
(43) Pub. Date: Mar. 21, 2024

(54) MULTI-SOLVENT PESTICIDAL COMPOSITIONS INCLUDING SULFOXIMINE

(71) Applicant: CLARKE MOSQUITO CONTROL PRODUCTS, INC., St. Charles, IL (US)

(72) Inventors: Laeticia LEROY RENE-BOISNEUF, Naperville, IL (US); Andrea LEVEY, Naperville, IL (US); Kattie Lynne MORRIS, Glendale Heights, IL (US); Yemi Susan BULLEN-MCCLAIN, Vernon Hills, IL (US)

(21) Appl. No.: 18/508,125

(22) Filed: Nov. 13, 2023

Related U.S. Application Data
(63) Continuation of application No. PCT/US2022/029460, filed on May 16, 2022.
Application No. PCT/US2022/029460 is a continuation-in-part of application No. 17/998,907, filed on Nov. 15, 2022.
(60) Provisional application No. 63/188,880, filed on May 14, 2021.
(60) Provisional application No. 63/025,725, filed on May 15, 2020.

(51) Int. Cl. A01N 51/00; A01N 25/02; A01P 7/04

(52) U.S. Cl. CPC A01N 51/00; A01N 25/02; A01P 7/04

(57) ABSTRACT

Pesticidal compositions may include an active ingredient, a solvent system, a first surfactant, and a second surfactant. The active ingredient may include a sulfoximine. The solvent system may include a polyalkylene carbonate solvent and a second solvent. The first surfactant may be an alkoxylated alcohol. The second surfactant may be an ethoxylated castor oil. Methods for pest control may include contacting a population of pests with a pesticidal composition. In some aspects, pesticidal compositions are particularly suited for use against pests from the order Nematocera, Brachycera, and/or Cyclorrhapha.

### CROSS-REFERENCE TO RELATED APPLICATION(S)

The present application a continuation of International (PCT) Patent Application No. PCT/US2022/029460, filed May 16, 2022, which is related to and claims the priority benefit of U.S. Provisional Patent Application No. 63/188,880, filed May 14, 2021, the entire contents of each of which are incorporated herein by reference. The present application is also a continuation-in-part of U.S. patent application Ser. No. 17/998,907, filed Nov. 15, 2022, which is a 371 National Phase entry of International (PCT) Patent Application No. PCT/US2021/032577, filed May 14, 2021, which is related to and claims the priority benefit of U.S. Provisional Patent Application No. 63/025,725, filed May 15, 2020, the entire contents of each of which are incorporated herein by reference.

### TECHNICAL FIELD

The present disclosure relates to pesticidal compositions and methods of use. More particularly, pesticidal compositions disclosed and contemplated herein include a sulfoximine and a multi-solvent system.

### INTRODUCTION

Agricultural pest populations may be controlled with application of pesticides. One technique uses Ultra Low Volume (ULV) technology, sometimes referred to as cold fogging. The pesticide is applied with specialized spray equipment mounted in aircraft, on the back of trucks, or even carried by hand. With this technique, aerosols are released to drift through a target zone. Chemical concentrates most often are used, and even if diluted, volumes of material used remain low. Preferably, the aerosol should persist in the air column for an appreciable length of time at suitable droplet densities to contact a target pest. Typically, the aerosol is generally only effective while the droplets remain airborne.

### SUMMARY

The present disclosure relates to pesticidal compositions and methods of use. In one aspect, a pesticidal composition is disclosed. The pesticidal composition may include an active ingredient including a sulfoximine, a solvent system including a polyalkylene carbonate solvent and a second solvent, a first surfactant that may be an alkoxylated alcohol, and a second surfactant that may be an ethoxylated castor oil.

In another aspect, a method for pest control is disclosed. The method may include contacting a population of pests with a pesticidal composition. The pesticidal composition may include an active ingredient including a sulfoximine, a solvent system including a polyalkylene carbonate solvent and a second solvent, a first surfactant that may be an alkoxylated alcohol, and a second surfactant that may be an ethoxylated castor oil.

There is no specific requirement that a material, technique or method relating to pesticidal compositions include all of the details characterized herein to obtain some benefit according to the present disclosure. Thus, the specific examples characterized herein are meant to be exemplary applications of the techniques described, and alternatives are possible.

### BRIEF DESCRIPTION OF THE DRAWINGS

FIG. 1 shows experimental laboratory data for mortality rates of Aedes aegypti mosquitos 48 hours after being contacted with samples including different amounts of an ethoxylated caster oil surfactant.

FIG. 2 shows experimental laboratory data for mortality rates of Aedes aegypti mosquitos 48 hours after being contacted with samples including different amounts of an alkoxylated alcohol surfactant.

FIG. 3 shows experimental laboratory data for mortality rates of Aedes aegypti mosquitos 48 hours after being contacted with samples including different amounts of alkoxylated alcohol surfactant and/or ethoxylated caster oil surfactant.

FIG. 4 shows experimental laboratory data for evaporation rates of samples including different amounts of alkoxylated alcohol surfactant and/or ethoxylated caster oil surfactant.

FIG. 5 shows a portion of the experimental laboratory data for evaporation rates shown in FIG. 4.

### DETAILED DESCRIPTION

Compositions, methods, and techniques disclosed and contemplated herein relate to pesticidal compositions. Pesticidal compositions disclosed herein include a sulfoximine as an active ingredient, which is soluble in few solvents. It was discovered that single-solvent systems including a sulfoximine as the active ingredient did not display satisfactory efficacy. Accordingly, pesticidal compositions disclosed herein include multi-solvent systems with suitable solvents.

It was also discovered that certain species of insects were susceptible to pesticidal compositions including certain surfactants but not other surfactants. In some instances, it was discovered that an amount of active ingredient in pesticidal compositions could be decreased, without losing efficacy, by including one or more suitable surfactants. Accordingly, pesticidal compositions disclosed herein may also include one or more surfactants. Exemplary pesticidal compositions may have a suitable physical profile and be effective against various species of pests whether applied aerially or via ground ULV applications.

### I. Definitions

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. The materials, methods, and examples disclosed herein are illustrative only and not intended to be limiting.

“Mosquito” is understood to refer to any specie of the roughly 3,500 species of the insect that is commonly associated with and given the common name “mosquito.” Mosquitoes span 41 insect genera, including the non-limiting examples of Aedes, Culex, Anopheles (carrier of malaria), Coquillettidia, and Ochlerotatus.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

### II. Exemplary Pesticidal Compositions

Exemplary pesticidal compositions may include various components at differing amounts. Exemplary pesticidal compositions may be designed as formulations that can be applied with hand-held, truck-mounted, and aerial ULV sprayers. In some instances, exemplary pesticidal compositions may be ready-to-use formulations that can be applied without dilution. Various aspects of exemplary pesticidal compositions are discussed below.

### A. Efficacy for Pests

Pesticidal compositions as described herein may be effective against various families of pests such as pests of order Diptera. Pesticidal compositions described herein may be effective against not only mosquitos, but also Nematocera (e.g., crane flies, midges, gnats), Brachycera (e.g., horse flies, robber flies, bee flies), and Cyclorrhapha (e.g., flies that breed in living or dead vegetable or animal material). Without being bound by a particular theory, the following discussion provides a possible basis for why pesticidal compositions may be effective against pests of the order Diptera.

Pests of order Diptera have exoskeletons (integument) that include a cuticle. The cuticle serves a variety of functions, one of which is protecting the insect from penetration of external compounds. The cuticle consists of different layers with distinct compositions and properties. The outermost layer, the epicuticle, is mainly composed of hydrocarbons, proteins, and lipids, and is commonly covered by a film of wax and cement (i.e., “wax phase”). Underneath the epicuticle is the procuticle, mainly composed of chitin fibers and proteins, which can be divided into the exocuticle (upper and harder part) and the endocuticle (lower and softer part) that is referred to as the “aqueous phase.” Lastly, a single layer of epidermal cells that secrete many of the cuticular components lies at the base of the cuticle.

Insect hydrocarbons are highly variable elements, varying from n-alkanes and methyl-branched alkanes to unsaturated hydrocarbons. Different insect orders have characteristic blends of these various hydrocarbons. Several families of cuticular proteins are found throughout arthropods, but others are restricted to a particular order, or even lower taxonomic groups (Willis (2010) Insect Biochemistry and Molecular Biology, 40(3), 189-204). In view of the foregoing, insects within an order generally comprise the same cuticular hydrocarbons and proteins and therefore have similar cuticles. Additionally, depending on the developmental stage and the body part, the composition and function of the cuticle changes. The basic architecture of the insect cuticle is, however, evolutionarily well conserved between developmental stages and between species. Accordingly, a composition that is effective at one point of development for a species is likely to be effective at a different point of development for that species. A composition that is effective for one species in an order is likely to be effective with another species in that order.

Pesticidal compositions described herein comprise an active ingredient and a solvent system. The solvent system affects insect cuticle penetration of the active ingredient by allowing passage of the active ingredient through the wax phase and to the aqueous phase where it saturates the aqueous phase. The efficacy of solvent system penetration depends on various physical factors including its ability to render the cuticle more permeable to the active ingredient (i.e., ability to penetrate through wax phase), its effect on the solubility of the active ingredient in water and wax (i.e., partition coefficient between wax and water), its effect on the saturation of the active ingredient in the aqueous phase (i.e., solubility of active ingredient in solvent in water), and boiling point of the solvent (i.e., volatility).

A solvent system wherein a first solvent possesses all but one of the foregoing physical factors may be paired with one or more additional solvents that possess the physical factor missing from the first solvent (i.e., complementary) to increase the efficacy of the active ingredient. For example, a first solvent results in a high rate of penetration of the active ingredient through wax, has a high partition coefficient between wax and water, the solubility of active ingredient in the first solvent in water is high, however, it has a high volatility. The first solvent is paired with a second solvent that lacks the foregoing physical factors, but has a low volatility, and therefore increases the efficacy of the active ingredient.

Given that the exoskeletons are similar within an order and that all exoskeletons comprise a wax phase and an aqueous phase, the compositions as described herein that have been shown to be efficacious for Culex sp. Mosquitos of order Diptera as a result of the solvent system in combination with the active ingredient, then the compositions as described herein may also be efficacious for other insects of order Diptera.

### B. Various Components of Exemplary Pesticidal Compositions

Exemplary pesticidal compositions include one or more active ingredients and a solvent system. Typically, exemplary pesticidal compositions may also include one or more surfactants. Exemplary pesticidal compositions may comprise, consist essentially of, or consist of, one or more components disclosed and contemplated herein.

Active ingredients suitable for use in exemplary pesticidal compositions are sulfoximines. A commercially available example of a sulfoximine is sulfoxaflor, available as Isoclast™ sold by Corteva Agriscience (Wilmington, Delaware). A chemical structure of sulfoxaflor is shown below:

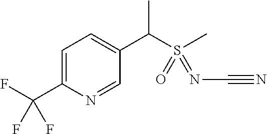 [SMILES: CC(c1ccc(C(F)(F)F)nc1)S(C)(=O)=NC#N]

Exemplary pesticidal compositions have a solvent system that includes multiple solvents. Typically, example solvent systems use two solvents.

A first solvent is usually a polyalkylene carbonate solvent. In some instances, the polyalkylene carbonate solvent may be a C₂₋₄ alkylene carbonate. For example, the polyalkylene carbonate solvent may be ethylene carbonate, propylene carbonate, or butane carbonate.

Suitable second solvents are typically esters. Example second solvents may include tributyl O-acetylcitrate (ACBT). Example second solvents may include methyl 5-(dimethylamino)-2-methyl-5-oxopentanoate, commercially available as Rhodiasolv PolarClean (Solvay). Example second solvents may include triethyl citrate.

Exemplary pesticidal compositions may include one or more surfactants. Example pesticidal compositions may include an alkoxylated alcohol (also referred to as alcohol alkoxylates) as a surfactant. Commercially available examples of alkoxylated alcohols include the Atplus™ (a C₉-C₁₁ alcohol ethoxylate/propoxylate) product line available from Croda (Edison, NJ), which includes Atplus™ 245.

Pesticidal compositions including two surfactants may include an ethoxylated castor oil as a surfactant. Commercially available examples of ethoxylated castor oils include the Alkamuls™ product line from Solvay (Brussels, Belgium), which includes Alkamuls EL-719.

Exemplary pesticidal compositions may include knockdown agent. In some instances, knockdown agent may include one or more pyrethroids. Exemplary pyrethroids include one or more of etofenprox, permethrin, prallethrin, resmethrin, sumithrin, allethrin, alpha-cypermethrin, bifenthrin, beta-cypermethrin, cyfluthrin, cypermethrin, deltamethrin, esfenvalerate, etofenprox, lamdba-cyhalothrin, or zeta-cypermethrin.

### C. Example Amounts of Various Components of Exemplary Pesticidal Compositions

Exemplary pesticidal compositions may include different amounts of various components. For instance, exemplary pesticidal compositions may include an active ingredient at 1.0 wt % (where wt % is percentage by weight) to 6.0 wt %. In various embodiments, a total amount of active ingredient present in exemplary pesticidal compositions may be 1.0 wt % to 5.5 wt %; 1.5 wt % to 6.0 wt %; 2.0 wt % to 6.0 wt %; 2.5 wt % to 5.5 wt %; 1.0 wt % to 5.0 wt %; 1.0 wt % to 4.0 wt %; 2.0 wt % to 5.0 wt %; 3.0 wt % to 6.0 wt %; 1.0 wt % to 3.0 wt %; 2.0 wt % to 4.0 wt %; 3.0 wt % to 5.0 wt %; 4.0 wt % to 6.0 wt %; 1.0 wt % to 2.0 wt %; 2.0 wt % to 3.0 wt %; 3.0 wt % to 4.0 wt %; 4.0 wt % to 5.0 wt %; or 5.0 wt % to 6.0 wt %. In various embodiments, the total amount of active ingredient in exemplary pesticidal compositions may be at least 1.0 wt %; at least 2.0 wt %; at least 2.5 wt %; at least 3.0 wt %; at least 4.0 wt %; or at least 5.0 wt %. In various embodiments, the total amount of active ingredient in exemplary pesticidal compositions may be no greater than 6.0 wt %; no greater than 5.5 wt %; no greater than 5.0 wt %; no greater than 4.0 wt %; no greater than 3.0 wt %; no greater than 2.0 wt %.

Exemplary pesticidal compositions may include various ratios of solvents. For instance, exemplary pesticidal compositions may include a ratio of polyalkylene carbonate solvent to second solvent of from 0.67:1 to 1.5:1. In various embodiments, exemplary pesticidal compositions may include a ratio of polyalkylene carbonate solvent to second solvent of 0.67:1; of 0.81:1; of 0.9:1; of 0.96:1; of 1:1; of 1.04:1; of 1.1:1; of 1.22:1; or of 1.5:1.

Exemplary pesticidal compositions may include various amounts of solvent, where the solvent comprises polyalkylene carbonate solvent and second solvent. For instance, exemplary pesticidal compositions may include 70 wt % to 92 wt % solvent. In various embodiments, a total amount of solvent in exemplary pesticidal compositions may be 70.0 wt % to 90.0 wt %; 74 wt % to 90.0 wt %; 70.0 wt % to 80.0 wt %; 80.0 wt % to 90.0 wt %; 73.0 wt % to 77.0 wt %; 79.0 wt % to 83.0 wt %; or 86.0 wt % to 92.0 wt %. In various embodiments, a total amount of solvent in exemplary pesticidal compositions may be at least 70.0 wt %; at least 74.0 wt; at least 80.0 wt %; at least 85.0 wt %; or at least 88.0 wt %. In various embodiments, a total amount of solvent in exemplary pesticidal compositions may be no greater than 92.0 wt %; no greater than 90.0 wt %; no greater than 85.0 wt %; no greater than 82.0 wt %; no greater than 76.0 wt %; or no greater than 73.0 wt %.

Exemplary pesticidal compositions may include various amounts of alkoxylated alcohol surfactant, such as from 1.0 wt % to 20.0 wt %. In various embodiments, a total amount of alkoxylated alcohol surfactant present in pesticidal compositions may be 1 wt % to 18 wt %; 3 wt % to 20 wt %; 5 wt % to 15 wt %; 2 wt % to 7 wt %; 3 wt % to 8 wt %; 4 wt % to 9 wt %; 5 wt % to 10 wt %; 1 wt % to 4 wt %; 4 wt % to 7 wt %; 7 wt % to 10 wt %; 10 wt % to 13 wt %; 13 wt % to 16 wt %; 2 wt % to 4 wt %; 4 wt % to 6 wt %; 6 wt % to 8 wt %; 8 wt % to 10 wt %; 5 wt % to 6 wt %; 6 wt % to 7 wt %; 7 wt % to 8 wt %; 8 wt % to 9 wt %; or 9 wt % to 10 wt %. In various embodiments, a total amount of alkoxylated alcohol surfactant present in pesticidal compositions may be at least 1 wt %; at least 3 wt %; at least 5 wt %; at least 6 wt %; at least 7 wt %; at least 8 wt %; at least 9 wt %; at least 10 wt %; at least 13 wt %; at least 16 wt %; or at least 19 wt %. In various embodiments, a total amount of alkoxylated alcohol surfactant present in pesticidal compositions may be no greater than 20 wt %; no greater than 17 wt %; no greater than 14 wt %; no greater than 11 wt %; no greater than 10 wt % no greater than 9 wt %; no greater than 8 wt %; no greater than 7 wt %; no greater than 6 wt %; no greater than 4 wt %; or no greater than 2 wt %.

Exemplary pesticidal compositions may include various amounts of ethoxylated castor oil surfactant, such as from 1.0 wt % to 20.0 wt %. In various embodiments, a total amount of ethoxylated castor oil surfactant present in pesticidal compositions may be 1 wt % to 18 wt %; 3 wt % to 20 wt %; 5 wt % to 15 wt %; 2 wt % to 7 wt %; 3 wt % to 8 wt %; 4 wt % to 9 wt %; 5 wt % to 10 wt %; 1 wt % to 4 wt %; 4 wt % to 7 wt %; 7 wt % to 10 wt %; 10 wt % to 13 wt %; 13 wt % to 16 wt %; 2 wt % to 4 wt %; 4 wt % to 6 wt %; 6 wt % to 8 wt %; 8 wt % to 10 wt %; 5 wt % to 6 wt %; 6 wt % to 7 wt %; 7 wt % to 8 wt %; 8 wt % to 9 wt %; or 9 wt % to 10 wt %. In various embodiments, a total amount of ethoxylated castor oil surfactant present in pesticidal compositions may be at least 1 wt %; at least 3 wt %; at least 5 wt %; at least 6 wt %; at least 7 wt %; at least 8 wt %; at least 9 wt %; at least 10 wt %; at least 13 wt %; at least 16 wt %; or at least 19 wt %. In various embodiments, a total amount of ethoxylated castor oil surfactant present in pesticidal compositions may be no greater than 20 wt %; no greater than 17 wt %; no greater than 14 wt %; no greater than 11 wt %; no greater than 10 wt %; no greater than 8 wt %; no greater than 6 wt %; no greater than 4 wt %; or no greater than 2 wt %.

Exemplary pesticidal compositions may include various ratios of surfactants. For instance, exemplary pesticidal compositions may include a ratio of alkoxylated alcohol surfactant to ethoxylated castor surfactant of from 0.25:1 to 1.18:1. In various embodiments, exemplary pesticidal compositions may include a ratio of alkoxylated alcohol surfactant to ethoxylated castor surfactant of 0.25:1; 0.3:1; 0.4:1 0.5:1; of 0.6:1; of 0.7:1; of 0.8:1; of 0.9:1; of 0.95:1; or 0.98:1.0; of 1:1; of 1.02:1; of 1.05:1; of 1.1:1; or of 1.18:1.

When present, exemplary pesticidal compositions may include 0.25 wt % to 1.5 wt % knockdown agent. In various embodiments, exemplary pesticidal compositions may include 0.25 wt % to 1.5 wt %; 0.5 wt % to 1.0 wt %; 0.25 wt % to 0.75 wt %; 0.75 wt % to 1.5 wt %; 0.6 wt % to 0.9 wt %; or 0.7 wt % to 0.8 wt % knockdown agent. In various embodiments, exemplary pesticidal compositions may include at least 0.25 wt %; at least 0.5 wt %; at least 0.7 wt %; at least 1.0 wt %; or at least 1.25 wt % knockdown agent. In various embodiments, exemplary pesticidal compositions may include no greater than 1.5 wt %; no greater than 1.25 wt %; no greater than 1.0 wt %; no greater than 0.8 wt %; or no greater than 0.5 wt % knockdown agent.

### D. Physical Characteristics of Exemplary Pesticidal Compositions

Exemplary pesticidal compositions may have a suitable physical profile and be effective against various species of pests whether applied aerially or via ground ULV applications. Typically, it is desirable for the pesticidal composition to persist in the air column for an appreciable length of time at suitable droplet densities to contact a pest. Characteristics that affect the desired profile include, but are not limited to, non-volatile fraction, density and evaporation rate.

Exemplary pesticidal compositions can be characterized by various physical attributes, such as density, particle size when applied, and non-volatile fraction. Exemplary pesticidal compositions may have a density of from about 1.0 g/mL to about 1.2 g/mL. In various embodiments, exemplary pesticidal compositions may have a density of from 1.0 g/mL to 1.2 g/mL; from 1.0 g/mL to 1.1 g/mL; or from 1.1 g/mL to 1.2 g/mL.

In exemplary embodiments, a pesticidal composition may have a non-volatile fraction from 50 wt % to 100 wt %; from 50 wt % to 75 wt %; or from 50 wt % to 60 wt %. In exemplary embodiments, a pesticidal composition may have a non-volatile fraction of more than about 50 wt %, or more than about 60 wt %, or more than about 75 wt %, or more than about 80 wt %. In exemplary embodiments, a pesticidal composition may have a non-volatile fraction of less than about 100 wt %, or less than about 90 wt %, or less than about 75 wt %, or less than about 60 wt %.

In exemplary embodiments, the pesticidal composition can be formulated for application or delivery as an aerosol or a fog wherein the pesticidal composition allows for the formation of droplets having an average diameter of less than 30 μm. Typically, droplets formed of exemplary pesticidal compositions may have an average diameter of 1 μm to 30 μm; 5 μm to 25 μm; 8 μm to 22 μm. Suitable pesticidal compositions for such a formulation typically should have a viscosity that allows for the pesticidal composition to atomize, but not be so thick as to clog the nozzle. Such viscosities can vary and be readily determined by one of skill in the art; however, a non-limiting common minimum viscosity is about 1 centistokes (cts).

### III. Exemplary Methods of Making

Exemplary pesticidal compositions disclosed and contemplated herein can be generally prepared by any appropriate manufacturing processes and using any appropriate manufacturing equipment such as is known in the art. Exemplary pesticidal compositions can be prepared by combining various components in an appropriate vessel (considering vessel size, amount of pesticidal composition to be made and reactivity of components) with mixing (e.g., stirring) until a uniform or homogeneous pesticidal composition is achieved. Various composition components can be added sequentially, with stirring between each addition to ensure dissolution and/or dispersion of the previous component.

In some instances, a solvent system is prepared before adding any additional components. For instance, a polyalkylene carbonate solvent may be combined with a second solvent to generate a solvent system. After mixing the polyalkylene carbonate solvent and the second solvent, an active ingredient may be added to the solvent system. After mixing the active ingredient in the solvent system, one or more surfactants may be added and mixed.

### IV. Exemplary Methods Use

Exemplary pesticidal compositions disclosed and contemplated herein can be used in methods for pest control, where the methods may include contacting a pest or a population of pests with an amount of any of the pesticidal compositions disclosed and contemplated herein. In some embodiments, methods of use may include contacting a pest with an amount of a pesticidal composition comprising, consisting essentially of, or consisting of an active ingredient including a sulfoximine, a solvent system including a polyalkylene carbonate solvent and a second solvent, a first surfactant that is an alkoxylated alcohol, and a second surfactant that is an ethoxylated caster oil.

In some embodiments, administration of the pesticidal composition provides droplets having an average diameter of less than 30 μm. In some embodiments, the pesticidal composition is applied as an aerosol or fog, and wherein the aerosol or fog contacts the population of pests. In some embodiments, the population of pests comprises pests from the order Diptera, such as Nematocera (e.g., crane flies, midges, gnats), Brachycera (e.g., horse flies, robber flies, bee flies), and Cyclorrhapha (e.g., flies that breed in living or dead vegetable or animal material).

In some embodiments, the methods described herein can comprise any known route, apparatus, and/or mechanism for the delivery or application of the compositions and formulations. In some embodiments, the method comprises a sprayer. Traditional pesticide sprayers in the pest control markets are typically operated manually or electrically or are gas-controlled and use maximum pressures ranging from 15 to 500 psi generating flow rates from 5 gpm to 40 gpm.

In some embodiments, the methods disclosed herein comprise the use of the compositions and/or formulations in combination with any low volume environmental pest control device(s) such as, for example, ultra low volume (ULV) machines. Such combinations are useful in methods for flying pest control (e.g., flies, gnats, flying ants, sand fleas, and the like) wherein contacting the insect with a low volume of the composition is possible and/or desirable. ULV machines use low volume of material, for example, at rates of about one gallon per hour (or ounces per minute), and typically utilize artificial wind velocities such as from, for example, an air source (e.g., pump or compressor) to break down and distribute the composition/formulation into a cold fog (e.g., having average droplet particle sizes of about 1-30 μm). Any standard ground ULV equipment used for adult mosquito control such as, for example, a system including a (CETI) aerosol generator can be used in the methods described herein. A general ULV system includes a tank for the pesticidal composition, a transport system (e.g., a pump or pressurized tank), a flow control device, and a nozzle that atomizes the composition. Typically, ULV machines do not compress droplets. Rather, they often use a venture siphoning system, and can induce an artificial energizing of the droplets by adding an electrical current to the liquid (e.g., through the use an electrode located at the application tip). (See, e.g., U.S. Pat. No. 3,516,608 (Bowen, et al.) incorporated herein by reference.)

### V. Experimental Examples

Experimental examples were conducted and the results are discussed below. These experimental examples suggest that exemplary pesticidal compositions would be efficacious against pests of the order Diptera.

### A. Laboratory Experimental Analysis of Solvents

In a laboratory environment, different co-solvents were tested with sulfoxaflor and propylene carbonate. Specifically, pesticidal compositions were prepared with sulfoxaflor, propylene carbonate and one of the following co-solvents: (i) Rhodiasolv PolarClean, (ii) tributyl O-acetylcitrate, and (iii) polyethylene glycol (PEG). Each sample included a 1:1 ratio of propylene carbonate and co-solvent. Then the samples were applied to Culex sp. mosquitos. Mortality rates of each sample are provided below in Table 1.

TABLE 1
Samples tested with different co-solvents
against Culex sp. mosquitos

| | 1-hour | 24 hour | 48 hour | 72 hour |
|---|---|---|---|---|
| Co-solvent | knockdown | mortality | mortality | mortality |
| PolarClean | 1% | 82% | 98% | 99% |
| tributyl O- | 20% | 99% | 100% | 100% |
| acetylcitrate | | | | |
| polyethylene | 2% | 41% | n/a | n/a |
| glycol (PEG) | | | | |

The results shown in Table 1 appear to show there is an impact of a second solvent on efficacy, which is unexpected because the co-solvent does not participate in the dissolution of sulfoxaflor. Without being bound to a particular theory, the co-solvent appears, however, to aid in penetration of the insecticide.

### B. Laboratory Experimental Analysis of Surfactants

Various amounts of different surfactants were evaluated to determine possible impacts on efficacy. In one set of trials, different amounts of sulfoxaflor were tested with and without a surfactant (Pluronic L92 from BASF). The samples included a 1:1 ratio of propylene carbonate and tributyl O-acetylcitrate. Then the three different formulations were tested against Culex sp. mosquitos, and the results are shown in Table 2 below.

TABLE 2
Samples tested with and without surfactant
against Culex sp. mosquitos

| Sulfoxaflor | Surfactant | 1-hour | | | |
|---|---|---|---|---|---|
| content | content | knock- | 24 hour | 48 hour | 72 hour |
| (wt. %) | (wt. %) | down | mortality | mortality | mortality |
| 1% | None | 18% | 62% | 94% | 98% |
| 0.5% | None | 0% | 27% | 76% | 86% |
| 0.5% | 20% | 2% | 64% | 92% | n/a |

The results in Table 2 indicate that adding a surfactant to the composition improved efficacy. Additionally, the pesticidal composition including surfactant displayed similar efficacy as the pesticidal composition including twice as much active ingredient, but without the surfactant.

### C. Laboratory Experimental Analysis of Surfactant Amounts

In a laboratory environment, various amounts of different surfactants were evaluated to determine possible impacts on efficacy.

To observe equivalent behavior to a ULV application in an outdoor environment, a spray chamber was used, which would require each sample to be diluted to 10% of its original content. For example, a sample containing 5 wt % active ingredient for outdoor field study should be tested in a laboratory at 0.5 wt % active ingredient content.

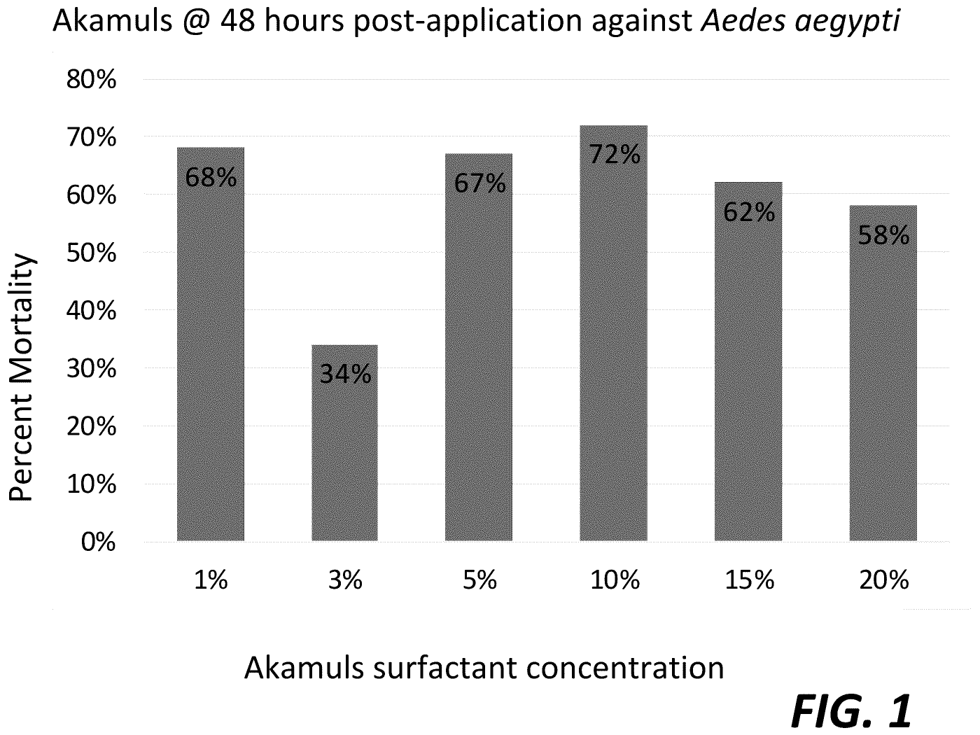

In one set of trials, differing amounts of Alkamuls™ were added to different samples of pesticidal compositions including 0.5 wt % sulfoxaflor, propylene carbonate and triethyl citrate, where the propylene carbonate and triethyl citrate were present in a 1:1 ratio. Aedes aegypti mosquitos were contacted with the samples and percent mortality was determined after 48 hours. Results are shown in FIG. 1 and indicate a non-linear response with a content of 10 wt % for Alkamuls™ by itself.

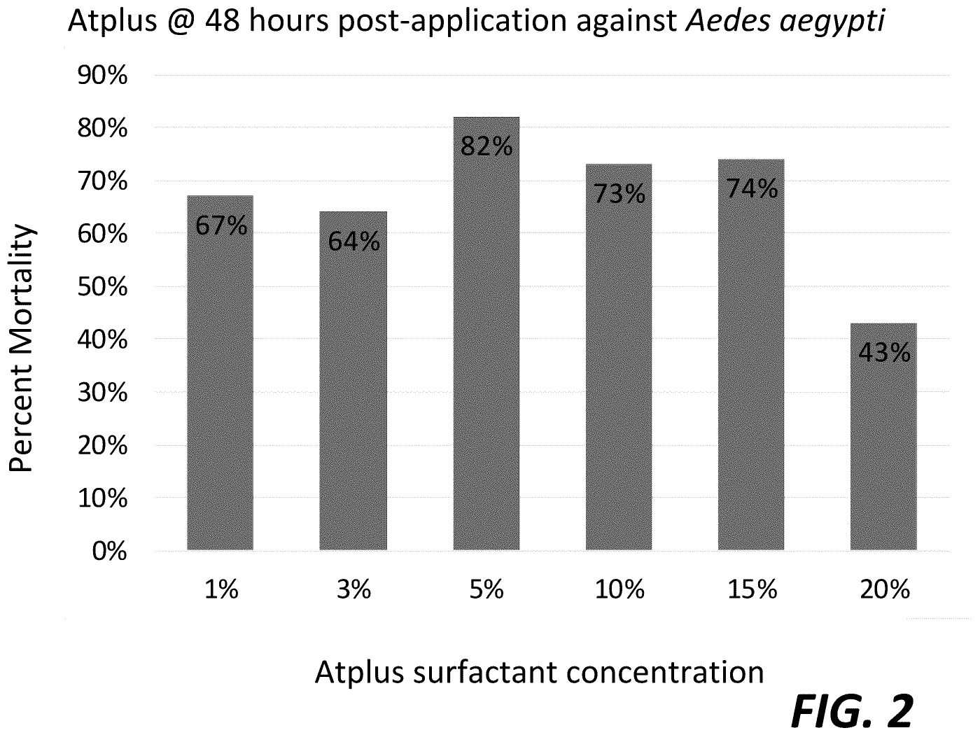

In another set of trials, differing amounts of Atplus were added to different samples of pesticidal compositions including 0.5 wt % sulfoxaflor, propylene carbonate and triethyl citrate, where the propylene carbonate and triethyl citrate were present in a 1:1 ratio. Aedes aegypti mosquitos were contacted with the samples and percent mortality was determined after 48 hours. Results are shown in FIG. 2 and indicate that a higher response was observed at 5 wt % surfactant and a non-linear response.

In another set of trials, varying amounts of Alkamuls™ and Atplus surfactants were added to different samples of pesticidal compositions including 0.5 wt % sulfoxaflor, propylene carbonate and triethyl citrate, where the propylene carbonate and triethyl citrate were present in a 1:1 ratio. The surfactants were added after the sulfoxaflor was mixed with the propylene carbonate and triethyl citrate. The different samples are described below in Table 3.

TABLE 3
Sample compositions tested against Aedes aegypti. Each
composition included 0.5 wt % sulfoxaflor, propylene
carbonate and triethyl citrate, where the propylene carbonate
and triethyl citrate were present in a 1:1 ratio

| Sample Number | Alkamuls (wt. %) | Atplus (wt. %) |
|---|---|---|
| #1 | 10 | 5 |
| #2 | 5 | 10 |
| #3 | 10 | 10 |
| #4 | 10 | 0 |
| #5 | 0 | 10 |
| #6 | 7.5 | 2.5 |
| #7 | 0 | 0 |
| #8 | 10 | 10 |
| #9 | 5 | 5 |
| #10 | 2.5 | 2.5 |
| #11 | 0 | 0 |
| #12 | 5 | 0 |
| #13 | 7.5 | 7.5 |
| #14 | 5 | 5 |
| #15 | 0 | 5 |

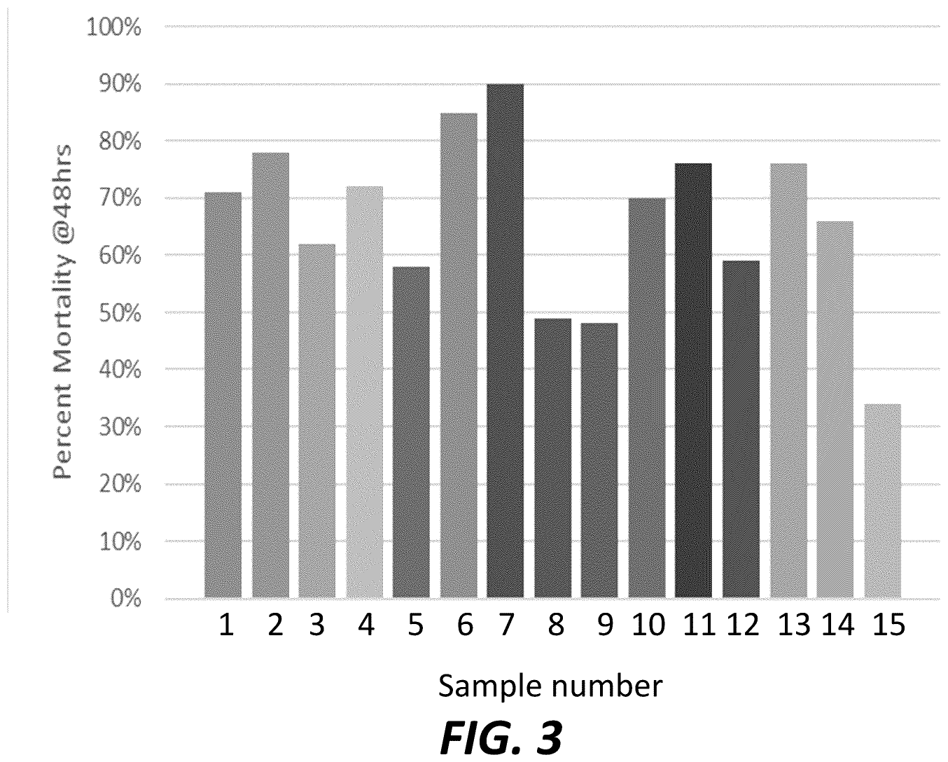

Results for the fifteen different samples after 48 hours are shown in FIG. 3. The impact on Aedes sp. mortality varied depending on the overall surfactant content and the ratio between the two surfactant families.

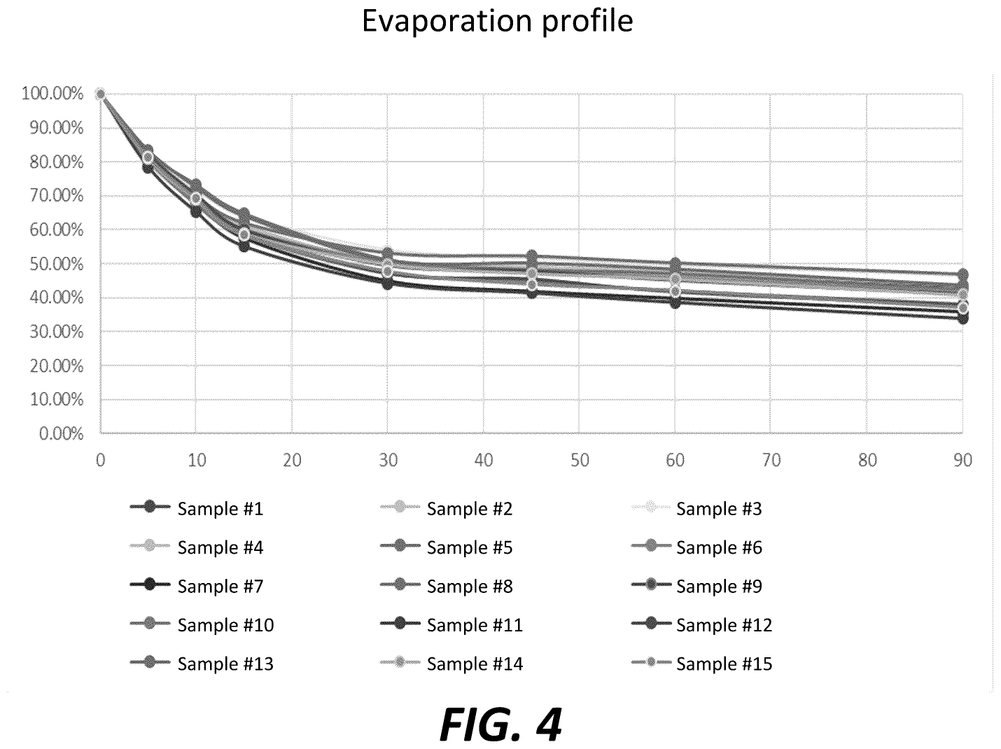

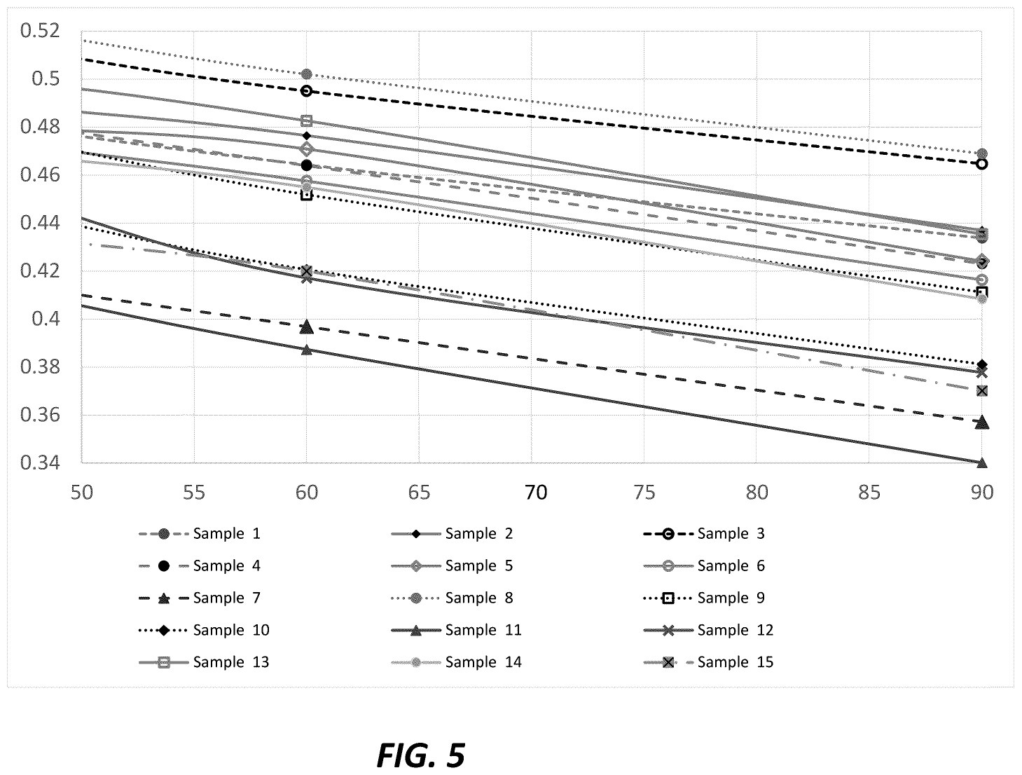

Evaporation profiles over 90 minutes for the samples shown in Table 3 are provided in FIG. 4. During the tests, a sample of known weight was placed in an oven heated to 90° C. and weight loss was monitored over time. FIG. 5 is an exploded view of a portion of FIG. 4, showing evaporation rates between 50 and 90 minutes. FIG. 4 and FIG. 5 show the range of evaporation rate (initial drop) and non-volatile fraction (plateau) for each of the fifteen samples.

### D. Laboratory Analysis of Exemplary Pesticidal Composition

In a laboratory environment, various physical parameters were evaluated for an exemplary pesticidal composition, Composition A, having the constituents as provided in Table 4 below.

TABLE 4
Composition of exemplary insecticidal Composition
A evaluated for physical parameters

| Components | Amount (wt. %) |
|---|---|
| Sulfoxaflor | 3.00% |
| Prallethrin | 0.75% |
| Atplus 245 | 7.50% |
| Alkamuls EL-719 | 7.50% |
| Propylene Carbonate | 40.63% |
| Triethyl Citrate | 40.63% |

Table 5 below shows the results of various tests performed on Composition A of Table 4. Certain physical properties were determined following guidelines provided by the Office of Prevention, Pesticides, and Toxic Substances (OPPTS), and the relevant OPPTS test numbers are also shown in Table 5. Spread factor was determined by microscopy. Miscibility with mineral was determined by mixing the same volume of sample and oil, shaking vigorously and letting the sample rest over time to observe any phase separation. Evaporation rate was determined by monitoring the weight loss at a certain temperature over 90 minutes. Viscosity was measured using a Brookfield viscometer. Flash point was measured using a Setaflash instrument. Density was measured using a pycnometer.

TABLE 5
Experimental results for various tests
performed on Composition A of Table 4

| | Notes | OPPTS 830.XXX |
|---|---|---|
| Formula Stability | | |
| A.I Storage Stability | Pass - <5% degradation | 830.6317 |
| | for CR3138 and <10% | |
| | for CR3060 | |
| Color | Yellow | 830.6302 |
| Odor | Mild ester, sweet | 830.6303 |
| PH | 7.08 | 830.7000 |
| Formula Properties | | |
| Viscosity | 20° C. = 18.72 cP, | 830.7100 |
| | 40° C. = 9.63 cP | |
| Spread Factor | 0.666 | |
| Miscibility with mineral | Immiscible at 50:50 ratio | |
| Flash Point (flammability) | 137.5° C. | 830.6315 |
| Density | 1.185 g/mL (9.889 | 830.7300 |
| | lb/gal) at 20° C. | |
| Evaporation rate | 42.87% volatile fraction | |

### E. Field Trials

Field trials were conducted for the pesticidal composition shown in Table 6 below.

TABLE 6
Pesticidal composition used during field trials.

| | Amount (wt. %) |
|---|---|
| Components | Composition A |
| Sulfoxaflor | 3.00 |
| Prallethrin | 0.75 |
| Atplus 245 | 7.50 |
| Alkamuls EL-719 | 7.50 |
| Propylene Carbonate | 40.63 |
| Triethyl Citrate | 40.63 |

The objective of these studies was to determine the efficacy of Composition A in an open field caged trial against adult Aedes aegypti, Culex quinquefasciatus, and Anopheles quadrimaculatus mosquitoes. For Composition A, the study was conducted in Lake Wales, Florida; Boone County, Illinois; Baytown, Texas; Bartow, Florida; and Beaufort, South Carolina.

Composition A was applied at an application rate of 1.0 oz./acre and a droplet VMD below 30 μm. Clarke Cougar ultra-low-volume (ULV) cold aerosol spray equipment was used in Florida, South Carolina, and Texas, and Clarke Grizzly ULV cold aerosol spray equipment was used in Illinois.

Mosquitoes used during the study were two- to six-day old adult females Aedes aegypti, Culex quinquefasciatus, and Anopheles quadrimaculatus. Pupae were provided by the Clarke insectary for the bioassay, the mosquitoes were reared and emerged in cages stored in a secure, temperature-controlled location. They were fed a 10% to 20% sugar water solution throughout the study period. The mosquitoes were visually inspected for accurate species identification and viability.

Approximately 15-30 mosquitoes were mouth-aspirated using aspirators with HEPA-filters into standard cylindrical cardboard spray cages (14.4 cm diameter by 3.81 cm wide) or holding cages. (Townzen, K. R. et al., 1973). Mosquito cages were then placed in an enclosed container and stored in a secure environment until placed in field for evaluation.

The treatment site consisted of an open grassy field large enough for a 1000-foot spray tangent and a 300-foot swath. Rotary slide impingers with Teflon-coated slides were placed on stakes adjacent to spray cages at 100, 200 and 300 feet of each replicate. Spray cages were placed on five-foot stakes, (three cages per stake, one cage per species), at an angle perpendicular to the spray line. Stakes were placed at 100, 200 and 300 feet down-wind at a 90° angle from the spray line. Cages were placed in one column 100 feet apart. A total of nine spray cages per species were used for each replicate, and one control cage per species was used per application rate (three replicates).

Teflon coated slides were used to sample the spray cloud at 100, 200, and 300 feet down wind of the spray truck tangent using Leading Edge Slide Impingers. Droplets were collected in each replicate and analyzed using a spread factor of 0.71 (Anderson, C. H. et al., 1971; May, K. R et al., 1950).

A Kestrel meteorological station was placed on site at a 30 foot elevation at the start of the trials to confirm temperature inversion. An additional Kestrel meteorological station was placed at five feet, including wind direction, wind speed, temperature, and relative humidity. Data was recorded at one-minute intervals after initial insecticide release (Christensen, P. W. et al., 1972).

Three replications, sometimes four replications, per application rate were made for this trial. Following each spray, the treated mosquitoes were allowed ten minutes of exposure and then transferred to clean holding cages for knockdown and mortality monitoring.

Mosquitoes were monitored at one hour for knockdown and 12, 24, 48, 72 and 96 hours for mortality. Mosquitoes were considered knocked down if they remained moribund after receiving a slight puff of air from the observer. For the mortality ratings, any movement by a mosquito required the observer to record the individual as alive.

Untreated control cages were used per three replicates. Control cages were placed upwind from the spray tangent during treatments to protect from contamination and were handled in a manner identical to treated mosquitoes.

1. Tests Against Aedes aegypti

Fifteen total spray replicates of Composition 4 were performed against Aedes aegypti female mosquitoes for this study. These spray replicates were conducted across five spatially distanced study locations: Polk County, FL, Beaufort County, SC, Maricopa County, AZ, Baytown, TX, and Boone County, IL.

Droplet size was 11.6 μm in Florida, Beaufort County, SC, and Baytown, TX, and 18.4 μm at Belvidere, Illinois.

Volume median diameter (VMD) and droplet densities (drops per square centimeter) were determined for 100 feet, 200 feet, and 300 feet distances following spray of Composition A. Results are shown in Table 7.

TABLE 7
Average droplet size (VMD) and drop densities
for Composition A at the various field sites.

| | | | Volume | |
|---|---|---|---|---|
| | | | Median | Droplet |
| Site | | Distance | Diameter | Density |
| (Replicate) | Location | (ft) | (VMD) | (per cm²) |
| Lake Wales, FL | 1 | 100 | 12.48 | 1494.60 |
| A | 3 | 100 | 8.00 | 1337.00 |
| | 5 | 200 | 8.73 | 967.40 |
| | 7 | 300 | 11.41 | 1587.00 |
| | 8 | 300 | 7.94 | 770.20 |
| | 9 | 300 | 8.37 | 745.40 |
| | Control | n/a | 7.88 | 438.40 |
| Lake Wales, FL | 1 | 100 | 8.33 | 663.10 |
| B | 3 | 100 | 10.28 | 1951.20 |
| | 5 | 200 | 11.31 | 1445.10 |
| | 6 | 200 | 9.93 | 1365.40 |
| | 7 | 300 | 9.79 | 1690.30 |
| | 9 | 300 | 9.29 | 717.40 |
| | Control | n/a | 5.76 | 683.80 |
| Lake Wales, FL | 1 | 100 | 9.80 | 1899.00 |
| C | 3 | 100 | 9.60 | 2384.30 |
| | 5 | 200 | 8.95 | 1255.50 |
| | 7 | 300 | 7.87 | 1695.70 |
| | 9 | 300 | 9.16 | 1835.70 |
| | Control | n/a | 8.05 | 2184.90 |
| Belvidere, IL | 1 | 100 | 17.31 | 533.00 |
| A | 3 | 100 | 15.26 | 343.60 |
| | 5 | 200 | 17.13 | 300.30 |
| | 7 | 300 | 15.87 | 181.30 |
| | 9 | 300 | 15.03 | 313.90 |
| | Control | n/a | 8.60 | 57.60 |
| Belvidere, IL | 1 | 100 | 17.84 | 302.20 |
| B | 3 | 100 | 16.36 | 343.60 |
| | 5 | 200 | 15.30 | 470.80 |
| | 7 | 300 | 16.81 | 526.00 |
| | 9 | 300 | 16.27 | 276.00 |
| | Control | n/a | 10.10 | 58.90 |
| Belvidere, IL | 1 | 100 | 10.90 | 67.00 |
| C | 2 | 100 | 10.20 | 64.20 |
| | 3 | 100 | 10.60 | 565.80 |
| | 5 | 200 | 10.40 | 492.00 |
| | 7 | 300 | 9.20 | 631.40 |
| | 9 | 300 | 11.00 | 623.20 |
| | Control | n/a | 7.30 | 30.10 |
| Baytown, TX | 1 | 100 | 12.66 | 891.20 |
| A | 3 | 100 | 11.32 | 873.6 |
| | 4 | 200 | 11.43 | 253.2 |
| | 5 | 200 | 12.79 | 1233.00 |
| | 7 | 300 | 11.36 | 364.3 |
| | 9 | 300 | 10.78 | 688.5 |
| | Control | n/a | 8.96 | 66.50 |
| Baytown, TX | 1 | 100 | 13.57 | 1384.4 |
| B | 3 | 100 | n/a | n/a |
| | 5 | 200 | 12.69 | 1216.2 |
| | 7 | 300 | 12.72 | 1059.3 |
| | 9 | 300 | 12.12 | 1238.7 |
| | Control | n/a | 9.96 | 124.6 |
| Baytown, TX | 1 | 100 | 10.07 | 690.3 |
| C | 3 | 100 | 10.41 | 756.6 |
| | 5 | 200 | 10.28 | 366.9 |
| | 7 | 300 | 9.87 | 815.3 |
| | 9 | 300 | 9.66 | 733.7 |
| | Control | n/a | 7.83 | 117.6 |
| Bartow, FL | 1 | 100 | 14.19 | 566.10 |
| A | 3 | 100 | 14.67 | 468.00 |
| | 5 | 200 | 13.91 | 667.00 |
| | 7 | 300 | 12.84 | 729.40 |
| | 9 | 300 | 11.76 | 963.20 |
| | Control | n/a | 0 | 0 |
| Bartow, FL | 1 | 100 | 10.61 | 582.90 |
| B | 3 | 100 | 13.37 | 599.70 |
| | 5 | 200 | 9.98 | 268.10 |
| | 7 | 300 | 11.08 | 543.20 |
| | 9 | 300 | 11.50 | 297.00 |
| | Control | n/a | 7.68 | 49.90 |
| Bartow, FL | 1 | 100 | 16.95 | 934.80 |
| C | 3 | 100 | 15.51 | 1103.30 |
| | 5 | 200 | 13.19 | 512.50 |
| | 7 | 300 | 11.12 | 315.90 |
| | 9 | 300 | 11.60 | 420.40 |
| | Control | n/a | 7.09 | 49.90 |
| Beaufort, SC | 1 | 100 | 26.80 | 1898.20 |
| A | 3 | 100 | 24.00 | 1188.90 |
| | 5 | 200 | 23.30 | 979.80 |
| | 7 | 300 | 21.00 | 783.00 |
| | 9 | 300 | 19.40 | 856.80 |
| | Control | n/a | 8.50 | 213.20 |
| Beaufort, SC | 1 | 100 | 26.60 | 852.70 |
| B | 3 | 100 | 25.30 | 1160.20 |
| | 5 | 200 | 21.50 | 705.20 |
| | 7 | 300 | 26.40 | 1057.70 |
| | 9 | 300 | 25.40 | 1164.30 |
| | Control | n/a | 5.50 | 282.88 |
| Beaufort, SC | 1 | 100 | 11.30 | 852.70 |
| C | 3 | 100 | 9.50 | 416.10 |
| | 5 | 200 | 8.50 | 453.00 |
| | 7 | 300 | 8.20 | 432.50 |
| | 8 | 300 | 5.70 | 321.80 |
| | 9 | 300 | 7.40 | 239.80 |
| | Control | n/a | 3.50 | 95.70 |

Tables 8, 9, 10, 11, and 12 below show mean mortality and median mortality results for application of Composition A to Aedes aegypti female mosquitos at the five field sites.

TABLE 8
Cumulative efficacy data from Lake Wales, FL spray
replicates against Ae. aegypti female mosquitoes.

| | Average | Average Mortality¹ | | Median Mortality | |
|---|---|---|---|---|---|
| Distance | Knockdown | 24 hour | 96 hour | 24 hour | 96 hour |
| 100 ft | 99.0% | 87.1%ª | 93.3%^{a} | 95.5% | 100% |
| 200 ft | 99.1% | 93.4%^{b} | 95.1%ª | 100% | 100% |
| 300 ft | 99.6% | 67.0%^{c} | 78.0%^{b} | 88.0% | 88.0% |
| Control | 0.0% | 0.2%^{d} | 1.4%c | 0.0% | 0.0% |

| | |
|---|---|
| Overall Average | 88.7% |
| (at 96 hours) | |

TABLE 9
Cumulative efficacy data for Belvidere, IL spray
replicates against Ae. aegypti female mosquitoes.

| | Mean 1-hour | Mean Mortality¹ | | Median Mortality | |
|---|---|---|---|---|---|
| Distance | Knockdown | 24-hour | 96-hour | 24-hour | 96-hour |
| 100 ft | 98.0% | 84.4%ª | 91.0%^{a} | 100% | 100% |
| 200 ft | 100% | 96.5%^{b} | 99.5%^{b} | 100% | 100% |
| 300 ft | 99.0% | 97.5%^{b} | 99.0%^{b} | 100% | 100% |
| Untreated Control | 0.0% | 1.2%^{c} | 1.5%^{c} | 0.0% | 0.0% |
| (upwind) | | | | | |

| | |
|---|---|
| Overall Average | 96.5% |
| (at 96 hours) | |

The mortality seen at station C1 was identified as an outlier in the data for stations at 100 ft from the spray line. When this position is removed from the data summary across all replicates, average mortality at 24 hours is 95.5%, with average mortality at 100 ft at 92.1% at the same timepoint.

TABLE 10
Cumulative efficacy data for Baytown, TX spray replicates
against Ae. aegypti female mosquitoes.

| | Mean 1-hour | Mean Mortality¹ | | Median Mortality | |
|---|---|---|---|---|---|
| Distance | Knockdown | 24-hour | 48-hour | 24-hour | 48-hour |
| 100 ft | 100%^{a} | 99.5%^{a} | 99.5%^{a} | 100% | 100% |
| 200 ft | 100%^{a} | 92.3%^{b} | 91.9%^{b} | 100% | 100% |
| 300 ft | 100%^{a} | 96.8%^{ab} | 98.2%^{a} | 100% | 100% |
| Untreated Control | 0.0%^{b} | 0.7%^{c} | 0.7%^{c} | 0.0% | 0.0% |
| (upwind) | | | | | |
| Overall Average | 96.4% | | | | |
| (at 48 hours) | | | | | |

TABLE 11
Cumulative efficacy data for Bartow, FL spray replicates
against Ae. aegypti female mosquitoes.

| | Mean 1-hour | Mean Mortality¹ | | Median Mortality | |
|---|---|---|---|---|---|
| Distance | Knockdown | 24-hour | 96-hour | 24-hour | 96-hour |
| 100 ft | 100% | 97.3%^{a} | 99.5%^{a} | 100% | 100% |
| 200 ft | 100% | 95.7%^{a} | 99.5%^{a} | 100% | 100% |
| 300 ft | 99.5% | 90.3%^{b} | 93.5%^{b} | 94.7% | 95.5% |
| Untreated Control | 0.2% | 1.1%^{c} | 4.4%^{c} | 0.0% | 4.8% |
| (upwind) | | | | | |

| | |
|---|---|
| Overall Mortality | 97.5% |

In Beaufort, SC, Stations C8 and C9 had the lowest observed droplet densities and VMDs of all spray replicates. Smaller droplet sizes along with reduced droplet densities can deliver doses of insecticide that are insufficient to induce mortality. When missed stations C8 and C9 and excluded from analysis, overall mortality at 96 hours post-spray across all replicates was 97.2%, with 98.0%, 95.2% and 98.7% mortality at 100-, 200- and 300-ft, respectively. Median mortality was 100% for every distance by 72 hours.

TABLE 12
Cumulative efficacy data from Beaufort, SC spray replicates
against Ae. Aegypti female mosquitoes.

| | Mean 1-hour | Mean Mortality¹ | | Median Mortality | |
|---|---|---|---|---|---|
| Distance | Knockdown | 24-hour | 96-hour | 24-hour | 96-hour |
| 100 ft | 100% | 96.1%^{a} | 98.0%^{a} | 100% | 100% |
| 200 ft | 100% | 88.5%^{b} | 95.2%^{b} | 95.7% | 100% |
| 300 ft | 100% | 83.5%^{b} | 90.6%^{b} | 90.9% | 100% |
| Control (upwind) | 0.0% | 0.7%^{c} | 1.8%^{c} | 0.0% | 0.0% |
| Overall Mortality | 94.6% | | | | |
| at 96 hours | | | | | |

With all spray replicates and stations included in analysis, the average mortality of spray cages placed 100 feet from the spray line at 96 hours post-spray was 96.1%, 96.1% for 200 feet and 91.5% for 300 feet (Table 13). Across all spray replicates and distances, overall mortality was 94.6%. Control mortality averaged 1.9% at 96 hours. Moribund values indicate the percentage of female mosquitoes that were dead or near-dead.

TABLE 13
Efficacy of Composition A against Aedes aegypti female mosquitoes.

| | | 24 hr | | 48 hr | | 72 hr | | 96 hr | |
|---|---|---|---|---|---|---|---|---|---|
| Distance | 1 hr KD | Mort. | Mori. | Mort. | Mori | Mort. | Mori | Mort. | Mori |
| All | 99.5% | 90.8% | 94.3% | 92.8% | 94.6% | 93.5% | 95.4% | 94.6% | 95.7% |
| 100 | 99.4% | 92.7% | 95.4% | 94.2% | 95.6% | 94.8% | 96.8% | 96.1% | 96.7% |
| 200 | 99.8% | 93.2% | 96.6% | 94.6% | 96.9% | 95.2% | 97.0% | 96.1% | 97.2% |
| 300 | 99.2% | 86.6% | 91.0% | 89.6% | 91.5% | 90.6% | 92.4% | 91.5% | 93.3% |

| | | | | | |
|---|---|---|---|---|---|
| Control | 0.0% | 0.7% | 1.0% | 1.4% | 1.9% |

When missed stations are removed from analysis, overall efficacy across all study locations is 96.0% at 96 hours post-spray. Mortality by distance with missed stations removed were 97.5%, 96.1% and 94.4% at 100-, 200- and 300 ft at 96 hours post-spray, with 1.9% mean mortality (Table 14).

TABLE 14
Efficacy of CMP 127-014 against Aedes aegypti female mosquitoes with missed
stations removed.

| | | 24 hr | | 48 hr | | 72 hr | | 96 hr | |
|---|---|---|---|---|---|---|---|---|---|
| Distance | 1 hr KD | Mort. | Mori. | Mort. | Mori | Mort. | Mori | Mort. | Mori |
| All | 99.6% | 92.1% | 95.4% | 94.1% | 95.8% | 94.7% | 96.3% | 96.0% | 97.0% |
| 100 | 99.5% | 94.3% | 97.0% | 95.8% | 97.2% | 96.4% | 98.4% | 97.5% | 98.1% |
| 200 | 99.8% | 93.2% | 96.6% | 94.6% | 96.9% | 95.2% | 97.0% | 96.1% | 97.2% |
| 300 | 99.5% | 90.2% | 94.1% | 93.5% | 94.7% | 94.0% | 95.1% | 94.4% | 95.6% |

| | | | | | |
|---|---|---|---|---|---|
| Control | 0.0% | 0.7% | 1.0% | 1.4% | 1.9% |

2. Tests for Anopheles quadrimaculatus

Fifteen total spray replicates of Composition 4 were performed against Anopheles quadrimaculatus female mosquitoes for this study. These spray replicates were conducted across five spatially distanced study locations: Polk County, FL, Beaufort County, SC, Maricopa County, AZ, Baytown, TX, and Boone County, IL.

Droplet size was 11.6 μm in Florida, Beaufort County, SC, and Baytown, TX, and 18.4 μm at Belvidere, Illinois.

Volume median diameter (VMD) and droplet densities (drops per square centimeter) were determined for 100 feet, 200 feet, and 300 feet distances following spray of Composition A. Results are shown in Table 15.

TABLE 15
Droplet data from spray replicates

| | | | Volume | |
|---|---|---|---|---|
| | | | Median | |
| Site | | Distance | Diameter | Droplet |
| (Replicate) | Location | (ft) | (VMD) | Density |
| Lake Wales, | 100 | 1 | 12.48 | 1494.60 |
| FL | 100 | 3 | 8.00 | 1337.00 |
| A | 200 | 5 | 8.73 | 967.40 |
| | 300 | 7 | 11.41 | 1587.00 |
| | 300 | 8 | 7.94 | 770.20 |
| | 300 | 9 | 8.37 | 745.40 |
| | n/a | Control | 7.88 | 438.40 |
| Lake Wales, | 100 | 1 | 8.33 | 663.10 |
| FL | 100 | 3 | 10.28 | 1951.20 |
| B | 200 | 5 | 11.31 | 1445.10 |
| | 200 | 6 | 9.93 | 1365.40 |
| | 300 | 7 | 9.79 | 1690.30 |
| | 300 | 9 | 9.29 | 717.40 |
| | n/a | Control | 5.76 | 683.80 |
| Lake Wales, | 100 | 1 | 9.80 | 1899.00 |
| FL | 100 | 3 | 9.60 | 2384.30 |
| C | 200 | 5 | 8.95 | 1255.50 |
| | 300 | 7 | 7.87 | 1695.70 |
| | 300 | 9 | 9.16 | 1835.70 |
| | n/a | Control | 8.05 | 2184.90 |
| Belvidere, IL | 100 | 1 | 17.31 | 533.00 |
| A | 100 | 3 | 15.26 | 343.60 |
| | 200 | 5 | 17.13 | 300.30 |
| | 300 | 7 | 15.87 | 181.30 |
| | 300 | 9 | 15.03 | 313.90 |
| | n/a | Control | 8.60 | 57.60 |
| Belvidere, IL | 100 | 1 | 17.84 | 302.20 |
| B | 100 | 3 | 16.36 | 343.6 |
| | 200 | 5 | 15.30 | 470.80 |
| | 300 | 7 | 16.81 | 526.00 |
| | 300 | 9 | 16.27 | 276.00 |
| | n/a | Control | 10.10 | 58.90 |
| Belvidere, IL | 100 | 1 | 10.90 | 67.00 |
| C | 100 | 2 | 10.20 | 64.20 |
| | 100 | 3 | 10.60 | 565.80 |
| | 200 | 5 | 10.40 | 492.00 |
| | 300 | 7 | 9.20 | 631.40 |
| | 300 | 9 | 11.00 | 623.20 |
| | n/a | Control | 7.30 | 30.10 |
| Baytown, TX | 100 | 1 | 10.07 | 690.30 |
| C | 100 | 3 | 10.41 | 756.60 |
| | 200 | 5 | 10.28 | 366.90 |
| | 300 | 7 | 9.87 | 815.30 |
| | 300 | 9 | 9.66 | 733.70 |
| | n/a | Control | 7.83 | 117.60 |
| Baytown, TX | 100 | 1 | 10.92 | 560.50 |
| D | 100 | 3 | 9.06 | 333.50 |
| | 200 | 5 | 10.71 | 622.10 |
| | 300 | 7 | 10.81 | 481.00 |
| | 300 | 9 | 10.64 | 218.60 |
| | n/a | Control | 6.85 | 82.80 |
| Baytown, TX | 100 | 1 | 8.25 | 361.50 |
| E | 100 | 3 | 7.09 | 610.90 |
| | 200 | 5 | 7.32 | 304.60 |
| | 300 | 7 | 8.35 | 705.90 |
| | 300 | 9 | 8.61 | 597.80 |
| | n/a | Control | 5.42 | 222.20 |
| Bartow, FL | 100 | 1 | 14.19 | 566.10 |
| A | 100 | 3 | 14.67 | 468.00 |
| | 200 | 5 | 13.91 | 667.00 |
| | 300 | 7 | 12.84 | 729.40 |
| | 300 | 9 | 11.76 | 963.20 |
| | n/a | Control | 0.00 | 0.00 |
| Bartow, FL | 100 | 1 | 10.61 | 582.90 |
| B | 100 | 3 | 13.37 | 599.70 |
| | 200 | 5 | 9.98 | 268.10 |
| | 300 | 7 | 11.08 | 543.20 |
| | 300 | 9 | 11.50 | 297.00 |
| | n/a | Control | 7.08 | 49.90 |
| Bartow, FL | 100 | 1 | 16.95 | 934.80 |
| C | 100 | 3 | 15.51 | 1103.30 |
| | 200 | 5 | 13.19 | 512.50 |
| | 300 | 7 | 11.12 | 315.90 |
| | 300 | 9 | 11.60 | 420.40 |
| | n/a | Control | 7.09 | 49.90 |
| Beaufort, SC | 100 | 1 | 26.80 | 1898.20 |
| A | 100 | 3 | 24.00 | 1188.90 |
| | 200 | 5 | 23.30 | 979.80 |
| | 300 | 7 | 21.00 | 783.00 |
| | 300 | 9 | 19.40 | 856.80 |
| | n/a | Control | 8.50 | 213.20 |
| Beaufort, SC | 100 | 1 | 26.60 | 852.70 |
| B | 100 | 3 | 25.30 | 1160.20 |
| | 200 | 5 | 21.50 | 705.20 |
| | 300 | 7 | 26.40 | 1057.70 |
| | 300 | 9 | 25.40 | 1164.30 |
| | n/a | Control | 5.50 | 282.88 |
| Beaufort, SC | 100 | 1 | 11.30 | 852.70 |
| C | 100 | 3 | 9.50 | 416.10 |
| | 200 | 5 | 8.50 | 453.00 |
| | 300 | 7 | 8.20 | 432.50 |
| | 300 | 8 | 5.70 | 321.80 |
| | 300 | 9 | 7.40 | 239.80 |
| | n/a | Control | 3.50 | 95.70 |

Tables 16, 17, 18, 19, and 20 below show mean mortality and median mortality results for application of Composition 4 to Anopheles quadrimaculatus female mosquitos at the five field sites.

TABLE 16
Cumulative efficacy data for Lake Wales, FL spray
replicates against Anopheles quadrimaculatus.

| | | Average Mortality¹ | | Median Mortality | |
|---|---|---|---|---|---|
| | Mean 1-hour | 24- | 96- | 24- | 96- |
| Distance | Knockdown | hour | hour | hour | hour |
| 100 ft | 97.6% | 72.2%^{a} | 96.7%^{a} | 76.2% | 100% |
| 200 ft | 99.5% | 77.2%^{a} | 94.7%^{a} | 90.5% | 100% |
| 300 ft | 100% | 70.9%^{a} | 93.9%^{a} | 76.9% | 100% |
| Untreated Control | 0.0% | 3.7%^{b} | 10.8%^{b} | 4.3% | 9.5% |
| (upwind) | | | | | |
| Overall Average | 95.1% | | | | |
| at 96 hours | | | | | |

Regarding Lake Wales, FL, the only station for which slides were read that exceeded 90% mortality had a droplet density greater than 2000 droplets/cm²—and was also the only location for which droplet density exceeded that of the control station. Stations which had lower droplet densities than the control station (C1, C5, C7, C9) had an average mortality of 57.4% at 72 hours and 79.8% at 96 hours, which may indicate a large portion of the droplets collected were background contamination. When these stations from replicate C are excluded from analysis (C1, C5, C7, C9), overall mortality with all other stations included was 97.8% at 96 hours. Average mortality at 96 hours with these stations excluded are 97.8%, 96.7% and 98.8% at 100-, 200- and 300 ft, respectively, with 100% median mortality at all three distances at the same time point.

TABLE 17
Cumulative efficacy data from Belvidere, IL spray
replicates against Anopheles quadrimaculatus.

| | | Average Mortality¹ | | Median Mortality | |
|---|---|---|---|---|---|
| | Mean 1-hour | 24 | 72 | 24 | 72 |
| Distance | Knockdown | hours | hours | hours | hours |
| 100 ft | 99.1% | 63.2%^{a} | 82.5% | 69.6% | 95.7% |
| 200 ft | 100% | 66.2%^{a} | 91.4% | 72.4% | 100% |
| 300 ft | 100% | 65.0%^{a} | 88.2%^{a} | 72.7% | 96.0% |
| Untreated Control | 0.2% | 2.3%^{b} | 6.3%^{c} | 0.0% | 5.0% |
| (upwind) | | | | | |
| Average | 87.4% | | | | |
| Mortality at 72 | | | | | |
| hours | | | | | |

For Belvidere, IL, without accounting for background contamination, droplet densities ranged from 64.2-631.4 droplets/cm². The highest and lowest droplet densities occurred during replicate C, with two stations in replicate C (C1 and C2) having droplet densities less than 100 droplets/cm². These two stations also had the lowest mortality across all replicates and distances (35% and 38% at stations C1 and C2, respectively). When these stations are removed from analysis (C1 and C2), average mortality at 100 ft across the three replicates is 95.8%, and overall mortality across the remaining stations and replicates is 91.4%.

TABLE 18
Cumulative efficacy data from Baytown, TX spray replicates
against Anopheles quadrimaculatus.

| | | Average Mortality¹ | | Median Mortality | |
|---|---|---|---|---|---|
| | Mean 1-hour | 24- | 96- | 24- | 96- |
| Distance | Knockdown | hour | hour | hour | hour |
| 100 ft | 98.0%^{a} | 65.8%^{a} | 91.0%^{a} | 69.6% | 100% |
| 200 ft | 100%^{a} | 57.1%^{a} | 91.9%^{a} | 63.6% | 94.4% |
| 300 ft | 99.1%^{a} | 56.4%^{a} | 92.3%^{a} | 50.0% | 95.5% |
| Untreated | 0.2%^{b} | 1.7%^{b} | 2.9%^{b} | 0.0% | 3.7% |
| Control | | | | | |
| (upwind) | | | | | |
| Overall | 91.6% | | | | |
| Average (at | | | | | |
| 96 hours) | | | | | |

TABLE 19
Cumulative efficacy data from Bartow, FL spray replicates
against Anopheles quadrimaculatus.

| | Mean 1-hour | Average Mortality¹ | | Median Mortality | |
|---|---|---|---|---|---|
| Distance | Knockdown | 24-hour | 48-hour | 24-hour | 48-hour |
| 100 ft | 100% | 79.0%^{a} | 92.0%^{a} | 81.8% | 91.7% |
| 200 ft | 99.5% | 77.5%^{a} | 91.0%^{a} | 78.3% | 95.0% |
| 300 ft | 99.0% | 78.0%^{a} | 87.7%^{a} | 76.4% | 86.4% |
| Untreated | 0.0% | 3.5%^{b} | 9.2%^{b} | 4.2% | 5.3% |
| Control | | | | | |
| (upwind) | | | | | |
| Overall | 90.1% | | | | |
| Average (at | | | | | |
| 48 hours) | | | | | |

TABLE 20
Cumulative efficacy data from Beaufort, SC spray
replicates against Anopheles quadrimaculatus.

| | Mean 1-hour | Average Mortality¹ | | Median Mortality | |
|---|---|---|---|---|---|
| Distance | Knockdown | 24-hour | 72-hour | 24-hour | 72-hour |
| 100 ft | 100% | 92.6%^{a} | 100%^{a} | 92.0% | 100% |
| 200 ft | 100% | 75.4%^{b} | 87.9%^{b} | 76.0% | 91.3% |
| 300 ft | 100% | 70.7%^{b} | 86.5%^{b} | 65.2% | 86.4% |
| Untreated | 0% | 3.0%^{c} | 7.4%^{c} | 0% | 5.3% |
| Control (upwind) | | | | | |
| Overall | 91.5% | | | | |
| Average (at | | | | | |
| 72 hours) | | | | | |

For Beaufort, SC, the two stations with the lowest droplet densities, C8 and C9, also had among the lowest observed mortalities at 62% and 74% mortality at 48 hours when readings were halted. When these stations are excluded from analysis, average mortality at 300 ft is 91.5% at 72 hours, with an overall mortality across all distances of 93.2%.

Overall mortality across all study locations and distances was 91.1%. With median mortality, all study locations and distances achieved at least 90% mortality within the designated time period. Overall median mortality was 95.2% when all distances and locations are combined. Across all study locations, overall mortality at 72 hours was 89.5% when missed stations are removed.

TABLE 21
Overall efficacy of Composition A against Anopheles quadrimaculatus by distance
with missed stations removed.

| | | 24 hr | | 48 hr | | 72 hr | | 96 hr | |
|---|---|---|---|---|---|---|---|---|---|
| Distance | 1 hr KD | Mort. | Mori. | Mort. | Mori | Mort. | Mori | Mort. | Mori |
| All | 99.4% | 73.4% | 96.0% | 90.6% | 96.5% | 92.5% | 97.1% | 94.3% | 97.2% |
| 100 ft | 99.1% | 78.8% | 95.1% | 91.7% | 96.1% | 93.4% | 96.9% | 95.3% | 97.1% |
| 200 ft | 99.8% | 71.3% | 93.9% | 91.4% | 97.1% | 92.4% | 97.3% | 94.0% | 97.4% |
| 300 ft | 99.2% | 70.4% | 93.9% | 86.4% | 93.7% | 89.7% | 94.6% | 91.2% | 94.7% |

| | | | | | |
|---|---|---|---|---|---|
| Control | 0.1% | 2.8% | 5.4% | 6.7% | 7.1% |

3. Tests for Culex quinquefasciatus

Seventeen total spray replicates of Composition 4 were performed against Culex quinquefasciatus female mosquitoes for this study. These spray replicates were conducted across five spatially distanced study locations: Polk County, FL, Beaufort County, SC, Maricopa County, AZ, Baytown, TX, and Boone County, IL.

Droplet size was 11.6 μm in Florida, Beaufort County, SC, and Baytown, TX, and 18.4 μm at Belvidere, Illinois.

Volume median diameter (VMD) and droplet densities (drops per square centimeter) were determined for 100 feet, 200 feet, and 300 feet distances following spray of Composition A. Results are shown in Table 22.

TABLE 22
Droplet data from spray replicates, where locations
1, 2 and 3 were 100 ft, locations 4, 5, and 6 were
200 ft, and locations 7, 8 and 9 were 300 ft.

| | | Volume Median | Droplet Density |
|---|---|---|---|
| Site (replicate) | Location | Diameter (VMD) | (per cm²) |
| Lake Wales, FL | 1 | 15.90 | 1967.60 |
| A | 3 | 15.25 | 431.00 |
| | 5 | 12.74 | 633.30 |
| | 7 | 12.57 | 480.00 |
| | 9 | 13.03 | 532.50 |
| | Control | 2.97 | 38.40 |
| Lake Wales, FL | 1 | 13.67 | 875.70 |
| B | 3 | 16.05 | 1003.30 |
| | 4 | 12.95 | 460.00 |
| | 5 | 13.49 | 744.60 |
| | 7 | 11.74 | 406.40 |
| | 9 | 12.26 | 438.10 |
| | Control | 4.59 | 132.90 |
| Lake Wales, FL | 1 | 16.18 | 812.70 |
| C | 3 | 4.72 | 349.30 |
| | 4 | 10.75 | 902.40 |
| | 5 | 10.75 | 1373.20 |
| | 7 | 10.83 | 128.10 |
| | 8 | 9.75 | 290.40 |
| | 9 | 10.50 | 492.50 |
| | Control | 6.43 | 32.00 |
| Belvidere, IL | 1 | 22.00 | 670.80 |
| A | 3 | 19.67 | 1339.50 |
| | 5 | 15.59 | 235.40 |
| | 7 | 13.60 | 476.30 |
| | 9 | 17.39 | 150.6 |
| | Control | 7.10 | 11.00 |
| Belvidere, IL | 1 | 15.83 | 505.70 |
| B | 3 | 16.23 | 257.40 |
| | 4 | 15.13 | 139.70 |
| | 5 | 14.03 | 325.50 |
| | 7 | 13.99 | 122.50 |
| | 9 | 15.84 | 305.10 |
| | Control | 15.03 | 14.00 |
| Belvidere, IL | 1 | 10.7 | 179.00 |
| C | 3 | 9.00 | 379.20 |
| | 5 | 10.9 | 83.40 |
| | 7 | 9.4 | 315.70 |
| | 9 | 10.1 | 705.2 |
| | Control | 8.9 | 10.9 |
| Belvidere, IL | 1 | 9.7 | 475.6 |
| D | 3 | 10.3 | 840.4 |
| | 5 | 9.6 | 180.4 |
| | 6 | 9.0 | 60.1 |
| | 7 | 11.0 | 229.6 |
| | 8 | 10.4 | 188.6 |
| | 9 | 9.1 | 105.2 |
| | Control | 8.8 | 6.8 |
| Baytown, TX | 1 | 12.66 | 891.20 |
| A | 3 | 11.32 | 873.6 |
| | 4 | 11.43 | 253.2 |
| | 5 | 12.79 | 1233.00 |
| | 7 | 11.36 | 364.3 |
| | 9 | 10.78 | 688.5 |
| | Control | 8.96 | 66.50 |
| Baytown, TX | 1 | 13.57 | 1384.4 |
| B | 3 | n/a | n/a |
| | 5 | 12.69 | 1216.2 |
| | 7 | 12.72 | 1059.3 |
| | 9 | 12.12 | 1238.7 |
| | Control | 9.96 | 124.6 |
| Baytown, TX | 1 | 10.07 | 690.3 |
| C | 3 | 10.41 | 756.6 |
| | 5 | 10.28 | 366.9 |
| | 7 | 9.87 | 815.3 |
| | 9 | 9.66 | 733.7 |
| | Control | 7.83 | 117.6 |
| Bartow, FL | 1 | 14.19 | 566.10 |
| A | 3 | 14.67 | 468.00 |
| | 5 | 13.91 | 667.00 |
| | 7 | 12.84 | 729.40 |
| | 9 | 11.76 | 963.20 |
| | Control | 0.00 | 0.00 |
| Bartow, FL | 1 | 10.61 | 582.90 |
| B | 3 | 13.37 | 599.70 |
| | 5 | 9.98 | 268.10 |
| | 7 | 11.08 | 543.20 |
| | 9 | 11.50 | 297.00 |
| | Control | 7.68 | 49.90 |
| Bartow, FL | 1 | 16.95 | 934.80 |
| C | 3 | 15.51 | 1103.30 |
| | 5 | 13.19 | 512.50 |
| | 7 | 11.12 | 315.90 |
| | 9 | 11.60 | 420.40 |
| | Control | 7.09 | 49.90 |
| Beaufort, SC | 1 | 26.80 | 1898.20 |
| A | 3 | 24.00 | 1188.90 |
| | 5 | 23.30 | 979.80 |
| | 7 | 21.00 | 783.00 |
| | 9 | 19.40 | 856.80 |
| | Control | 8.50 | 213.20 |
| Beaufort, SC | 1 | 26.60 | 852.70 |
| B | 3 | 25.30 | 1160.20 |
| | 5 | 21.50 | 705.20 |
| | 7 | 26.40 | 1057.70 |
| | 9 | 25.40 | 1164.30 |
| | Control | 5.50 | 282.88 |
| Beaufort, SC | 1 | 11.30 | 852.70 |
| C | 3 | 9.50 | 416.10 |
| | 5 | 8.50 | 453.00 |
| | 7 | 8.20 | 432.50 |
| | 8 | 5.70 | 321.80 |
| | 9 | 7.40 | 239.80 |
| | Control | 3.50 | 95.70 |
| Beaufort, SC | 1 | 10.60 | 885.50 |
| D | 2 | 8.40 | 664.20 |
| | 3 | 8.20 | 549.40 |
| | 4 | 7.20 | 791.20 |
| | 5 | 7.80 | 479.70 |
| | 6 | 6.00 | 426.40 |
| | 7 | 7.00 | 799.40 |
| | 9 | 7.70 | 520.70 |
| | Control | 4.70 | 520.70 |

Tables 23, 24, 25, 26 and 27 below show mean mortality and median mortality results for application of Composition 4 to Culex quinquefasciatus female mosquitos at the five field sites.

TABLE 23
Cumulative efficacy data of replicates performed in
Lake Wales, FL against Culex quinquefasciatus.

| | Mean 1-hour | Average Mortality | | Median Mortality | |
|---|---|---|---|---|---|
| Distance | Knockdown | 24-hour | 96-hour | 24-hour | 96-hour |
| 100 ft | 100% | 96.1% | 100% | 100% | 100% |
| 200 ft | 100% | 94.1% | 99.5% | 100% | 100% |
| 300 ft | 91.4% | 70.8% | 87.6% | 80.0% | 100% |
| Untreated Control | 0.0% | 0.6% | 0.6% | 0.0% | 0.0% |
| (upwind) | | | | | |
| Overall | 95.6 | | | | |
| Mortality at | | | | | |
| 96 hours | | | | | |

Regarding Lake Wales, FL, mortality at station C7 was identified as an outlier amongst the 300 ft efficacy data. Excluding this location from the cumulative data summary, efficacy at all three distances exceeds the 90% threshold by 72 hours. With C7 removed from the dataset, overall efficacy at all other test stations averages 98.8% at 96 hours, with 100% average mortality at 100 and 200 feet and 96.8% at 300 feet.

TABLE 24
Cumulative Efficacy Data from Belvidere, IL Spray
Replicates against Culex quinquefasciatus.

| | Mean 1-hour | Average Mortality | | Median Mortality | |
|---|---|---|---|---|---|
| Distance | Knockdown | 24-hour | 96-hour | 24-hour | 96-hour |
| 100 ft | 99.2% | 80.4% | 87.9% | 97.7% | 100% |
| 200 ft | 90.7% | 65.3% | 74.5% | 80.0% | 86.4% |
| 300 ft | 95.5% | 51.1% | 60.5% | 51.4% | 64.7% |
| Untreated | 0.0% | 0.2% | 0.9% | 0.0% | 0.0% |
| Control (upwind) | | | | | |

| | |
|---|---|
| Overall Mortality | 74.3% |

TABLE 25
Mortality data against Culex quinquefasciatus in Baytown, TX

| | Mean 1-hour | Average Mortality | | Median Mortality | |
|---|---|---|---|---|---|
| Distance | Knockdown | 24-hour | 72-hour | 24-hour | 72-hour |
| 100 ft | 99.5%^{a} | 98.6%^{a} | 98.1% | 100% | 100% |
| 200 ft | 99.5%^{a} | 90.4% | 93.9% | 100% | 100% |
| 300 ft | 100%^{a} | 91.4%^{a} | 94.1% | 95.5% | 100% |
| Untreated Control | 0.0%^{b} | 0.5%^{b} | 0.3% | 0.0% | 0.0% |
| (upwind) | | | | | |

| | |
|---|---|
| Overall Mortality | 95.4% |

TABLE 26
Cumulative efficacy data for Bartow, FL spray
replicates against Culex quinquefasciatus.

| | Mean 1-hour | Mean Mortality | | Median Mortality | |
|---|---|---|---|---|---|
| Distance | Knockdown | 24-hour | 96-hour | 24-hour | 96-hour |
| 100 ft | 100% | 98.8% | 99.4% | 100% | 100% |
| 200 ft | 98.5% | 90.8% | 97.4% | 90.5% | 100% |
| 300 ft | 98.0% | 94.4% | 95.9% | 100% | 100% |
| Untreated Control | 0.0% | 0.5% | 3.9% | 0.0% | 0.0% |
| (upwind) | | | | | |
| Overall | 97.5% | | | | |
| Mortality | | | | | |

TABLE 27
Cumulative mortality data for Beaufort, SC spray
replicates against Culex quinquefasciatus.

| | | Average Mortality | | Median Mortality | |
|---|---|---|---|---|---|
| | Mean 1-hour | 24- | 96- | 24- | 96- |
| Distance | Knockdown | hour | hour | hour | hour |
| 100 ft | 97.9% | 83.6% | 90.4% | 100% | 100% |
| 200 ft | 79.5% | 63.4% | 66.8% | 82.6% | 93.5% |
| 300 ft | 92.5% | 52.1% | 63.0% | 63.9% | 78.7% |
| Untreated Control | 0.0% | 0.2% | 1.2% | 0.0% | 0.0% |
| (upwind) | | | | | |
| Overall Mortality | 73.2% | | | | |
| at 96 hours | | | | | |

Regarding Beaufort, SC, when replicate D is removed from analysis on the basis of the spray cloud missing the field due to a wind shift, average mortality is 88.8%. Excluding replicate D, median mortality for the remaining stations exceeds 90% at all treatment distances at 72-hours post-spray.

With all locations and replicates included, average mortality at 96 hours post-spray is 85.3%, with control mortality averaging 1.3%. Average mortality at 100-ft exceeded 90%, while mortality at 200- and 300-ft was 84.2% and 77.5%, respectively. With missed stations removed from analysis, average mortality of all study locations was 93.2% at 96 hours. Average mortality exceeds 90% at 100- and 200-ft, while average mortality at 300-ft is 87.1%. Median mortality, when missed stations are excluded, (Table 29) was 100% at all distances within 72 hours, with 0.7% median control mortality. All distances had 100% median knockdown, and all distances had greater than 90% median mortality within 24 hours

TABLE 28
Efficacy of Composition A against Culex quinquefasciatus female mosquitoes with all
spray replicates included.

| | | 24 hr | | 48 hr | | 72 hr | | 96 hr | |
|---|---|---|---|---|---|---|---|---|---|
| Distance | 1 hr KD | Mort. | Mori. | Mort. | Mori | Mort. | Mori | Mort. | Mori |
| All | 95.5% | 80.1% | 84.0% | 84.1% | 85.3% | 85.6% | 86.2% | 86.3% | 86.6% |
| 100 | 99.2% | 90.2% | 92.2% | 92.4% | 93.3% | 93.9% | 94.1% | 94.3% | 94.5% |
| 200 | 92.3% | 78.6% | 83.0% | 83.9% | 83.9% | 83.7% | 84.0% | 84.2% | 84.3% |
| 300 | 95.1% | 68.9% | 74.0% | 74.1% | 75.9% | 76.5% | 77.6% | 77.6% | 78.2% |

| | | | | | |
|---|---|---|---|---|---|
| Control | 0.0% | 0.4% | 0.6% | 0.7% | 1.3% |

TABLE 29
Median efficacy of Composition A against Culex quinquefasciatus female mosquitoes
with missed stations and replicates excluded.

| | | 24 hr | | 48 hr | | 72 hr | | 96 hr | |
|---|---|---|---|---|---|---|---|---|---|
| Distance | 1 hr KD | Mort. | Mori. | Mort. | Mori | Mort. | Mori | Mort. | Mori |
| All | 100% | 100% | 100% | 100% | 100% | 100% | 100% | 100% | 100% |
| 100 | 100% | 100% | 100% | 100% | 100% | 100% | 100% | 100% | 100% |
| 200 | 100% | 100% | 100% | 100% | 100% | 100% | 100% | 100% | 100% |
| 300 | 100% | 90.9% | 100% | 95.2% | 100% | 100% | 100% | 100% | 100% |

| | | | | | |
|---|---|---|---|---|---|
| Control | 0.0% | 0.0% | 0.0% | 0.0% | 0.0% |

### EXEMPLARY EMBODIMENTS

For reasons of completeness, various aspects of the technology are set out in the following numbered embodiments:

Embodiment 1. A pesticidal composition comprising:
an active ingredient including a sulfoximine;
a solvent system including a polyalkylene carbonate solvent and a second solvent;
a first surfactant that is an alkoxylated alcohol; and
a second surfactant that is an ethoxylated castor oil.
   Embodiment 2. The pesticidal composition according to Embodiment 1, further comprising a knockdown agent comprising a pyrethroid.
   Embodiment 3. The pesticidal composition according to Embodiment 1 or Embodiment 2, comprising 0.25 wt % to 1.5 wt % knockdown agent.
   Embodiment 4. The pesticidal composition according to any one of Embodiments 1-3, wherein the pesticidal composition includes, by weight percentage, 1% to 20% first surfactant and 1% to 20% second surfactant.
   Embodiment 5. The pesticidal composition according to any one of Embodiments 1-4, wherein the sulfoximine is sulfoxaflor.
   Embodiment 6. The pesticidal composition according to any one of Embodiments 1-5, wherein the second solvent is tributyl O-acetylcitrate.
   Embodiment 7. The pesticidal composition according to any one of Embodiments 1-6, wherein the second solvent is triethyl citrate.
   Embodiment 8. The pesticidal composition according to any one of Embodiments 1-7, wherein the polyalkylene carbonate is propylene carbonate.
   Embodiment 9. The pesticidal composition according to any one of Embodiments 1-8, wherein the pesticidal composition includes, by weight percentage, 5% to 10% first surfactant and 5% to 10% second surfactant.
   Embodiment 10. The pesticidal composition according to any one of Embodiments 1-9, wherein the first surfactant and the second surfactant are present in the pesticidal composition in a ratio of 0.9:1 to 1.10:1 by weight percent.
   Embodiment 11. The pesticidal composition according to any one of Embodiments 1-10, wherein the pesticidal composition includes, by weight percentage, 1% to 6% active ingredient.
   Embodiment 12. The pesticidal composition according to any one of Embodiments 1-11, wherein a density of the pesticidal composition is no less than 1.0 g/mL and no greater than 1.2 g/mL.
   Embodiment 13. The pesticidal composition according to any one of Embodiments 1-12, wherein the pesticidal composition has a non-volatile fraction of 50 wt % to 75 wt %.
   Embodiment 14. A method for pest control, the method comprising:
contacting a population of pests with a pesticidal composition, the pesticidal composition comprising:
   an active ingredient including a sulfoximine;
   a solvent system including a polyalkylene carbonate solvent and a second solvent;
   a first surfactant that is an alkoxylated alcohol; and
   a second surfactant that is an ethoxylated castor oil.
      Embodiment 15. The method according to Embodiment 14, wherein administration of the pesticidal composition provides droplets having an average diameter of less than 30 μm.
      Embodiment 16. The method according to Embodiment 14 or Embodiment 15, wherein the pesticidal composition is applied as an aerosol or fog, and wherein the aerosol or fog contacts the population of pests.
      Embodiment 17. The method according to any one of Embodiments 14-16, wherein the pesticidal composition is applied using an ultra low volume (ULV) sprayer.
      Embodiment 18. The method according to any one of Embodiments 14-17, wherein the population of pests comprises pests from the sub-orders Nematocera, Brachycera, and/or Cyclorrhapha.
      Embodiment 19. The method according to any one of Embodiments 14-18, further comprising a knockdown agent comprising a pyrethroid, and wherein the pesticidal composition includes, by weight percentage, 1% to 6% active ingredient.
      Embodiment 20. The method according to any one of Embodiments 14-19, wherein the pesticidal composition includes, by weight percentage, 5% to 10% first surfactant and 5% to 10% second surfactant;
wherein the first surfactant and the second surfactant are present in the pesticidal composition in a ratio of 0.9:1 to 1.10:1 by weight percent;
wherein a density of the pesticidal composition is no less than 1.0 g/mL and no greater than 1.2 g/mL; and
wherein the pesticidal composition has a non-volatile fraction of 50 wt % to 75 wt %.

The foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use, may be made without departing from the spirit and scope of the disclosure.

What is claimed is:

1. A pesticidal composition comprising:
an active ingredient including a sulfoximine;
a solvent system including a polyalkylene carbonate solvent and a second solvent;
a first surfactant that is an alkoxylated alcohol; and
a second surfactant that is an ethoxylated castor oil.

2. The pesticidal composition according to claim 1, further comprising a knockdown agent comprising a pyrethroid.

3. The pesticidal composition according to claim 2, comprising 0.25 wt % to 1.5 wt % knockdown agent.

4. The pesticidal composition according to claim 1, wherein the pesticidal composition includes, by weight percentage, 1% to 20% first surfactant and 1% to 20% second surfactant.

5. The pesticidal composition according to claim 1, wherein the sulfoximine is sulfoxaflor.

6. The pesticidal composition according to claim 1, wherein the second solvent is tributyl O-acetylcitrate.

7. The pesticidal composition according to claim 1, wherein the second solvent is triethyl citrate.

8. The pesticidal composition according to claim 1, wherein the polyalkylene carbonate solvent is propylene carbonate.

9. The pesticidal composition according to claim 1, wherein the pesticidal composition includes, by weight percentage, 5% to 10% first surfactant and 5% to 10% second surfactant.

10. The pesticidal composition according to claim 9, wherein the first surfactant and the second surfactant are present in the pesticidal composition in a ratio of 0.9:1 to 1.10:1 by weight percent.

11. The pesticidal composition according to claim 10, wherein the pesticidal composition includes, by weight percentage, 1% to 6% active ingredient.

12. The pesticidal composition according to claim 11, wherein a density of the pesticidal composition is no less than 1.0 g/mL and no greater than 1.2 g/mL.

13. The pesticidal composition according to claim 12, wherein the pesticidal composition has a non-volatile fraction of 50 wt % to 75 wt %.

14. A method for pest control, the method comprising:
contacting a population of pests with a pesticidal composition, the pesticidal composition comprising:
an active ingredient including a sulfoximine;
a solvent system including a polyalkylene carbonate solvent and a second solvent;
a first surfactant that is an alkoxylated alcohol; and
a second surfactant that is an ethoxylated castor oil.

15. The method according to claim 14, wherein administration of the pesticidal composition provides droplets having an average diameter of less than 30 μm.

16. The method according to claim 15, wherein the pesticidal composition is applied as an aerosol or fog, and wherein the aerosol or fog contacts the population of pests.

17. The method according to claim 14, wherein the pesticidal composition is applied using an ultra low volume (ULV) sprayer.

18. The method according to claim 14, wherein the population of pests comprises pests from the sub-orders Nematocera, Brachycera, and/or Cyclorrhapha.

19. The method according to claim 14, further comprising a knockdown agent comprising a pyrethroid, and wherein the pesticidal composition includes, by weight percentage, 1% to 6% active ingredient.

20. The method according to claim 19, wherein the pesticidal composition includes, by weight percentage, 5% to 10% first surfactant and 5% to 10% second surfactant;
wherein the first surfactant and the second surfactant are present in the pesticidal composition in a ratio of 0.9:1 to 1.10:1 by weight percent;
wherein a density of the pesticidal composition is no less than 1.0 g/mL and no greater than 1.2 g/mL; and
wherein the pesticidal composition has a non-volatile fraction of 50 wt % to 75 wt %.
